(19) United States
(12) Patent Application Publication
(10) Pub. No.: US 2024/0362502 A1
(43) Pub. Date: Oct. 31, 2024

(54) MACHINE LEARNING-BASED TROUBLESHOOTING ANALYSIS ENGINE TO IDENTIFY CAUSES OF COMPUTER SYSTEM ISSUES

(71) Applicant: HEWLETT PACKARD ENTERPRISE DEVELOPMENT LP, Spring, TX (US)

(72) Inventors: Ting-Wei Tsai, Taipei City (TW); Pramod M. Kabbali, Taipei City (TW); Yao-Huan Chung, Taipei City (TW)

(21) Appl. No.: 18/307,148

(22) Filed: Apr. 26, 2023

(51) Int. Cl. G06N 5/022

(52) U.S. Cl. CPC G06N 5/022; G06Q 30/015

(57) ABSTRACT

A process includes responsive to an issue occurring with the computer system, receiving, by a troubleshooting analysis engine, data from the computer system representing information about the computer system. The process includes processing, by the troubleshooting analysis engine, the data to identify a parameter of the computer system having an unexpected value; and searching, by the troubleshooting analysis engine, a design database to identify a design infrastructure of the computer system that is causally linked to the issue. The process includes analyzing, by the troubleshooting analysis engine, the design infrastructure using machine learning to identify a candidate cause of the issue.

### BACKGROUND

A computer system may experience various problems, or issues, over its lifetime, which may cause the computer system to fail or otherwise not meet expectations. The issues may be attributable to any of a number of different causes, including invalid combinations of hardware and/or software, software corruption, hardware faults, software vulnerabilities, software bugs, configuration settings, as well as other causes.

### BRIEF DESCRIPTION OF THE DRAWINGS

FIG. 1 is a block diagram of a computer network that includes a troubleshooting analysis engine that uses artificial intelligence to diagnose root causes of computer system issues according to an example implementation.

FIG. 2 is a block diagram of the troubleshooting analysis engine of FIG. 1 according to an example implementation.

FIG. 3 is a flow diagram depicting actions taken by components of the troubleshooting analysis engine to diagnose a root cause of a central processing unit (CPU) underperformance issue according to an example implementation.

FIG. 4 is an illustration of a power supply circuit identified by the troubleshooting analysis engine as being correlated to the CPU underperformance issue according to an example implementation.

FIG. 5 is a flow diagram depicting a technique that uses machine learning to identify a candidate cause of an issue occurring with a computer system according to an example implementation.

FIG. 6 is a block diagram of an apparatus having instructions that cause a processor to use machine learning to identify a candidate cause of an issue occurring with a computer system according to an example implementation.

FIG. 7 is an illustration of machine-readable instructions stored on a non-transitory machine-readable storage medium to cause a machine to use machine learning to identify a candidate cause of an issue occurring with a computer system according to an example implementation.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology that is used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

A computer system manufacturer may provide technical support services for purposes of diagnosing root causes of problems, or issues, that occur with computer systems that originate with the manufacturer. In this context, an “issue” with a computer system refers to an observed behavior of the computer system, which differs from an expected standard for the observed behavior.

Some computer system issues may be readily recognized by human users. For example, a computer system may unexpectedly power down or undergo a reset. As another example, a computer system may display or send an error message. As another example, a user may notice a lag in the responsiveness of a computer system. As another example, software of a computer system may terminate abruptly or crash. As another example, a computer system may be unable to communicate through a particular network interface. As another example, a user may be notified by the computer system that the installation of a particular software or hardware component was unsuccessful.

Other computer system issues may be recognized using tools (e.g., performance analysis software). As another example, a tool may reveal that a central processing unit (CPU) of a computer system may be underperforming (e.g., the CPU may be operating at a lower than expected frequency). As another example, some computer system issues may be revealed through event logs.

There may be a number of potential reasons, or causes, why a computer system experiences a particular issue. For example, a hardware component of the computer system may have failed. As another example, software of the computer system may have been corrupted. As another example, the computer system may have been subjected to a security intrusion.

Some causes of computer system issues may be due to upgrades or changes that were made by the end user. For example, an issue may arise due to software and/or hardware being installed by the end user. Particular combinations of hardware, particular combinations of software and/or particular combinations of hardware and software may be incompatible with each other, thereby causing issues with the computer system. Customization of a computer system by the end user may result in a computer system that has unsupported options, firmware corresponding to an invalid or unsupported firmware version, a driver that is not supported, an incompatible software component, an incompatible hardware component or other issues.

A particular issue with a computer system may be resolved by diagnosing the root cause of the issue and then addressing the root cause. In this context, the “root cause” of an issue with a computer system refers to the primary reason why the issue occurred. By fixing a computer system to remove the root cause of an issue, any secondary cause(s) that arise from the root cause may disappear. Addressing a root cause may include applying any of a number of measures, such as, as examples, swapping out a hardware component, changing a configuration setting, uninstalling incompatible software, installing newer version software, installing newer version software, removing an incompatible hardware component, as well as applying other measures.

In some cases, diagnosing the root cause of a computer system issue may be rather straightforward. For example, an error message or a logged error record may reveal the root cause. As another example, a history of issues and identified root causes for a particular computer system may readily reveal the root cause of a current issue with the computer system. As another example, a knowledge database may associate certain issues with known root causes. However, the root causes of some issues may be considerably challenging to diagnose. For example, for a relatively complex issue, one or multiple teams of engineers (e.g., a hardware team, a software team and a platform team) may analyze the issue to derive the likely root cause(s). Diagnosing such complex issues may consume a significant amount of time and resources from both the viewpoints of the manufacturer of a computer system and the end consumer.

In accordance with example implementations that are described herein, a manufacturer may provide a centralized troubleshooting analysis engine, which uses artificial intelligence to diagnose root causes of computer system issues. As described further herein, the troubleshooting analysis engine using artificial intelligence includes the engine using machine learning-based classifiers to solve classification problems related to issue diagnoses. The automation that is provided by the troubleshooting analysis engine may significantly reduce the amount of time and resources that are otherwise consumed resolving computer system issues.

More specifically, in accordance with some implementations, when an issue occurs with a computer system (herein called a “computer system under evaluation”), a user may (via a graphical user interface (GUI) of a client device, for example) submit an issue ticket to the centralized troubleshooting analysis engine. The issue ticket, in accordance with example implementations, identifies a particular issue with the computer system. As an example, the troubleshooting analysis engine may be provided by an original equipment manufacturer (OEM) of the computer system, may be hosted on one or multiple servers, and may be accessible through the internet. In response to the issue ticket, the troubleshooting analysis engine may gather data (“called system information data” herein) about the computer system. The system information data may include data gathered directly from the computer system, such as, for example, data representing system event logs, register contents, hardware component model numbers, hardware component identifiers and software version numbers.

The troubleshooting analysis engine may also gather at least some of the system information data from sources that are external to the computer system. As an example, the troubleshooting analysis engine may search a knowledge database for historical data (e.g., data representing recorded issues, issue analyses and diagnoses) that has been accumulated from similar computer systems. As an example, the similar computer systems may be computer systems that share the same model number as the computer system under evaluation. As another example, the information may include historical data that was gathered directly from other computer systems that have one or multiple similar subsystems as the computer system under evaluation. As an example, these other computer systems may share the same power supply control subsystem, fan control subsystem, motherboard, bridge chip set, input/output (I/O) subsystem and/or CPU architecture. As another example, the information may include historical data that is stored in a knowledge database and was gathered directly from the computer system under evaluation at a prior time (e.g., responsive to the processing of another issue ticket). As other examples, the system information data may include data stored in database, which sets forth diagnoses and/or determined solutions for other computer systems and/or similar subsystems of the computer system under evaluation.

In accordance with example implementations, the troubleshooting analysis engine determines whether an issue that is experienced by the computer system under evaluation is correlated to a particular design infrastructure of the computer system. In this context, a “design infrastructure” of the computer system refers to a subsystem of the computer system that is associated with providing one or multiple functions for the computer system. In accordance with example implementations, the issue being “correlated” to the particular design infrastructure refers to the issue having an association with the design infrastructure such that a particular component or components of the design infrastructure are likely to be candidate root cause(s) of the issue.

As an example, a design infrastructure may be a particular subsystem of the computer system, which manages the logic level of a CPU hot signal. The CPU hot signal may be asserted (e.g., driven to a logic one state) to cause the CPU to reduce its clock speed. As another example, a design infrastructure may be a particular subsystem of the computer system that manages fan speeds. As another example, a design infrastructure may be an I/O subsystem. As another example, a design infrastructure may be a network interface. As another example, a design infrastructure may be a bus interface. As another example, a design infrastructure may be a storage controller. As another example, a design infrastructure may be a security subsystem (e.g., a subsystem including a baseboard management controller (BMC)). As another example, a design infrastructure may be a motherboard. As another example, a design infrastructure may be a power management subsystem. As another example, a design infrastructure may be an I/O bridge.

The design infrastructure may be software or firmware. Moreover, the design infrastructure may be solely hardware, solely software, solely firmware or a combination of two or more of the foregoing. For example, a design infrastructure may include a microcontroller (or subpart thereof) and a certain firmware routine or set of routines executed by the microcontroller.

The troubleshooting analysis engine may determine if an issue is correlated to a particular design infrastructure of the computer system in any of a number of different ways. As an example, the troubleshooting analysis engine may apply a set of correlation rules to the system information data for purposes of identifying a design infrastructure of the computer system that is correlated to the issue. Each correlation rule may, for example, be associated with a particular design infrastructure and provide an indication (e.g., a Boolean indication or a correlation coefficient) of whether the particular issue is correlated to the associated design infrastructure. The correlation rule may, for example, receive, as its inputs, data representing the issue and possibly other information (e.g., a model number of the computer system, hardware component identifiers, software or firmware versions, parameter values or other information), and the correlation rule may generate an output representing whether the design infrastructure associated with the rule is correlated with the issue.

As another example of a way the troubleshooting analysis engine may determine whether a particular design infrastructure is correlated to an issue, the troubleshooting analysis engine may access a database that contains records that correspond to respective issues. Each record may contain a set of correlation coefficients, which is associated with a particular issue. Each correlation coefficient, in turn, may be associated with a particular design infrastructure. Therefore, as an example, for a particular issue, the troubleshooting analysis engine may access the corresponding record and compare the correlation coefficients to a threshold. Accordingly, by determining which correlation coefficient(s) meet or exceed the threshold, the troubleshooting analysis engine identifies the associated design infrastructure(s). The correlation coefficients may be derived based on historical data pertaining to issues and the design infrastructures that were identified as being associated with the issues.

As another example, the troubleshooting analysis engine, in accordance with further implementations, may use one or multiple machine learning classifiers for purposes of identifying design infrastructures that are correlated to issues. In this context, a “classifier” refers to a machine learning algorithm that sorts, or categorizes, an input into one or multiple categories, or groups, called “classes.” Here, the “input” refers to certain features, or characteristics, of the information about the computer system under evaluation and the issue, and the classes correspond to different design infrastructures of the computer system. In accordance with some implementations, these features may be provided to the classifier in the form of a feature vector.

Regardless of the way that the troubleshooting analysis engine identifies a particular design infrastructure that is correlated with an issue, the troubleshooting analysis engine may search a design infrastructure database to retrieve data describing the design infrastructure. Data describing a design infrastructure may be in one of many different forms. As an example, for a design infrastructure that is a circuit, data describing the circuit may include netlist data that describes connections among hardware components (e.g., functional hardware modules and/or logic gates) of the circuit. As another example, for a design infrastructure that is a circuit, the data may represent hardware description language that describes the circuit at a register-transfer-logic (RTL) level. As another example, for a design infrastructure that is firmware or software, the data may represent a pseudo code-based description of the firmware/software. As another example, for a design infrastructure that is software or firmware, the data may represent a programming language representation (e.g., C+ code) of the firmware or software.

The troubleshooting analysis engine, in accordance with example implementations, applies one or multiple machine learning-based classifiers (herein called “root cause classifiers”) to the design infrastructure(s) that are correlated to the issue for purposes of identifying one or multiple candidate root causes of the issue. For this purpose, in accordance with some implementations, the troubleshooting analysis engine may provide a feature vector to a root cause classifier, which represents features related to the classification problem, such as features of the design infrastructure (e.g., features derived from the data describing the design infrastructure, features of the issue (e.g., features derived from the issue ticket data) and features of the computer system (e.g., features derived from the system information data).

In accordance with example implementations, a root cause classifier may, for a particular issue, classify the feature vector as belonging to multiple classes. Stated differently, the root cause classifier may identify multiple candidate root causes for a given issue. In this manner, each candidate root cause is a likely root cause of the issue, with one of the candidate root causes likely being the actual root cause of the issue. In accordance with some implementations, the root cause classifier provides an indication of the likelihood, or confidence level, for a particular candidate root cause classification. For example, the root cause classifier may identify candidate root cause A and candidate root cause B for a given issue, and the root cause classifier may assign a likelihood of 75% to candidate root cause A (i.e., a likelihood of 75% that root cause A is the actual root cause of the issue) and a likelihood of 25% to candidate root cause B (i.e., a likelihood of 25% that root cause B is the actual root cause of the issue).

In accordance with example implementations, a candidate root cause may be an element of the design infrastructure that is correlated to the issue. For example, if the design infrastructure is a circuit of the computer system, then the classes for the classification problem may correspond to particular elements (e.g., resistors, capacitors, voltage regulator packages, transistors, or other elements) of the circuit. As another example, if the design infrastructure is a software routine of the computer system, then the classes for the classification problem may correspond to particular elements (e.g., application programming interface (API) calls or library loading calls) of the software routine.

Among the benefits of the troubleshooting analysis engine, the engine may provide more timely, more accurate and more consistent diagnoses of computer system issues. Moreover, the troubleshooting analysis engine may serve as a gatekeeper to tightly control access to design infrastructure information for the computer system. In this manner, design infrastructure information may be considered by the manufacturer of the computer system to be proprietary and confidential information. Therefore, strictly controlling access to design infrastructure information while allowing this information to be used for troubleshooting is beneficial for both the manufacturer and the customers.

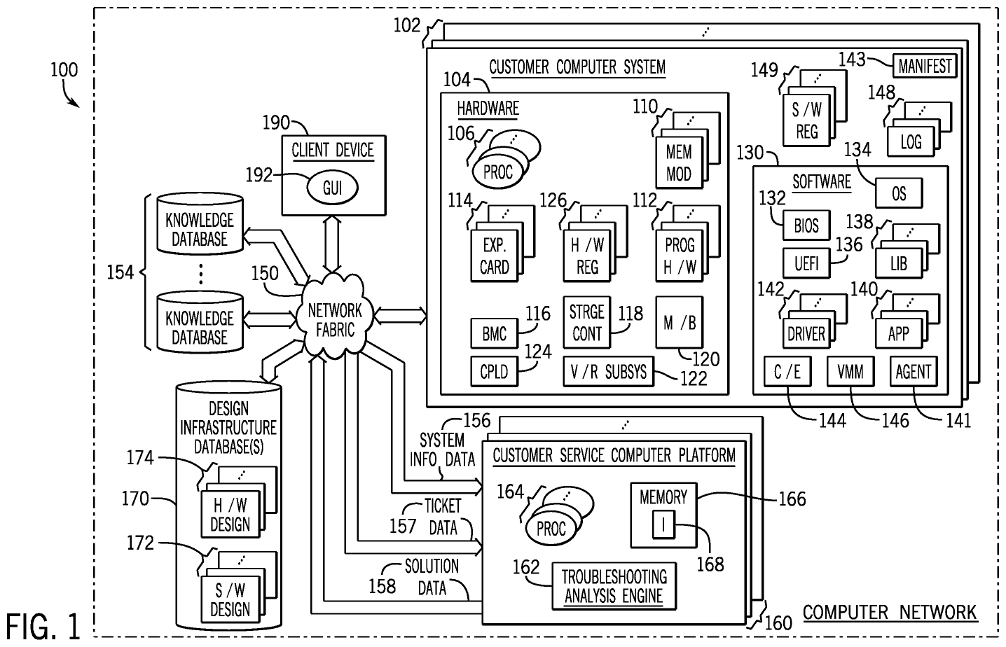

Referring to FIG. 1, as a more specific example, in accordance with some implementations, a computer network 100 includes one or multiple customer service computer platforms 160 that provide one or multiple troubleshooting analysis engines 162. In accordance with some implementations, each customer service computer platform 160 may host an instance of a respective troubleshooting analysis engine 162. In accordance with further implementations, a troubleshooting analysis engine 162 may be distributed across multiple computer service computer platforms 160. In this manner, each customer service computer platform 160 may host an instance of a subcomponent of a distributed troubleshooting analysis engine 162.

A “computer platform,” as used herein, refers to an electronic device that has a processing resource, which is capable of executing machine-readable instructions (e.g., “software”). As examples, a computer platform may be a server computer (e.g., a blade server, a rack server or a standalone server), a desktop computer, a notebook computer, a tablet computer, a smartphone, a storage array, a network switch, a wearable computer, a network gateway, or another electronic device that has a processing resource.

As depicted in FIG. 1, the customer service computer platform(s) 160 may be coupled to customer computer systems 102 and client devices 190 via network fabric 150. A given customer computer system 102 (also referred to as a “computer system 102 under evaluation” herein) may experience a particular problem, or issue, and, as described herein, the issue may be resolved by a troubleshooting analysis engine 162. For example implementations that are described herein, a client device 190 may be a mechanism used by a user to report an issue with a troubleshooting analysis engine 162 (via an issue ticket). The network fabric 150 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof.

The client devices 190, in accordance with example implementations, may be associated with users of the computer systems 102. As an example, a client device 190 may be an electronic device (e.g., a computer platform) that is separate from a customer computer system 102 under evaluation, and a user may use the client device 190 to communicate (e.g., submit an issue ticket, receive analysis results indicating candidate root cause(s) of the issue, and so forth) with a troubleshooting analysis engine 162. In some examples, the client device 190 may be the customer computer system 102 under evaluation or another customer computer system 102.

As depicted in FIG. 1, in accordance with some implementations, the client device 190 may include a graphical user interface (GUI) 192 that allows a user to input information related to an issue for a particular customer computer system 102. FIG. 1 depicts components of a specific customer computer system 102-1. Other customer computer systems 102 may have similar or different designs and architecture, in accordance with example implementations. In accordance with example implementations, the GUI 192 may allow a user to create an issue ticket and send data (called “issue ticket data 157” or “ticket data 157” herein) representing the issue ticket to a troubleshooting analysis engine 162. The issue ticket may, for example, identify a particular customer computer system 102 under evaluation and describe the nature of an issue for the customer computer system 102. For purposes of generating the ticket, the GUI 192 may provide menu options or other features to aid the user in properly identifying characteristics of the issue. In accordance with further implementations, a GUI (in lieu of the GUI 192) may be provided by a web-based server that is accessible through an internet browser and is in communication with the troubleshooting analysis engine 162.

A specific customer computer system 102 having specific hardware 104 and software 130 is depicted in FIG. 1 and described herein. Other customer computer system 102 may have similar and/or different architectures and/or different hardware and software component manifests, in accordance with example implementations. Moreover, although in the following description, the troubleshooting analysis engine 162 is described herein as provided a troubleshooting service for customer computer systems on behalf of a manufacturer of the computer systems, in accordance with further implementations, the troubleshooting analysis engine 162 may be hosted on resources that are managed by another entity. For example, in accordance with further implementations, the troubleshooting analysis engine 162 may be dedicated to troubleshooting issues for computer systems of an enterprise and be hosted on resources that are managed by the enterprise. As another example, in accordance with further implementations, the troubleshooting analysis engine 162 may be hosted on resources managed by an entity other than a computer system manufacturer for purposes of troubleshooting issues for computer systems managed by other entities.

The troubleshooting analysis engine 162 may, in response to the issue ticket, gather system information data 156 about the customer computer system 102 under evaluation. The gathering of the system information data 156 may include the troubleshooting analysis engine 162 gathering information directly from the customer computer system 102. For this purpose, in accordance with some implementations, the customer computer system 102 may have a local agent 141 that gathers the system information data from the customer computer system 102 and sends the data to the troubleshooting analysis engine 162. As an example, the local agent 141, in accordance with some implementations, may be a process that executes on the computer system, such as, for example a daemon or diagnostic software. In accordance with some implementations, the local agent 141 may be installed on the customer computer system 102 by the troubleshooting analysis engine 162.

In accordance with some implementations, the system information data 156 may include additional system information data that is gathered by the troubleshooting analysis engine 162 during the course of the engine's analysis and diagnosis of the issue. As an example, the additional system information data may include data representing one or multiple software design infrastructures 172 and/or one or multiple hardware design infrastructures 174 of the customer computer system 102-1, which may be stored in one or multiple design infrastructure databases 170. As another example, the additional system information data may include information that is stored in one or multiple knowledge databases 154, such as historical parameter values (used to derive normal, or expected, ranges and values), correlation information, labeled machine learning training data based on historical results, and other information.

The troubleshooting analysis engine 162 uses artificial intelligence, as described herein, to identify one or multiple candidate root causes for an issue. The troubleshooting analysis engine 162 may communicate solution data 158 representing the candidate route cause(s) to the client device 190. As examples, the troubleshooting analysis engine 162 may communicate the solution 158 data directly to the client device 190 or to a server in communication with the client device 190, which represents the candidate root cause(s). As an example, the GUI 192 may display the candidate root cause(s).

In accordance with some implementations, the troubleshooting analysis engine 162 may, for certain root causes, initiate remedial actions to resolve the issues. For example, if a root cause for a given issue is related to a configuration setting of the customer computer system 102, the troubleshooting analysis engine 162 (with the permission of the user) may adjust the configuration setting to resolve the issue. As another example, if a root cause for a given issue is related to an incompatible version of software installed on the customer computer system 102, the troubleshooting analysis engine 162 (with the permission of the user) may upgrade the software to a compatible version.

Some root causes may not be resolved without involvement of a technician or a user who has physical possession of the customer computer system 102. For example, a resolution may involve the replacement of a hardware component of the customer computer system 102 (e.g., swapping out an option card, replacing a power supply unit, or replacing a resistor mounted to a motherboard). As another example, a resolution may involve the user providing or downloading software or firmware corresponding to a particular version.

In the context used herein, a “computer system,” such as the customer computer system 102, may be a logical or physical entity that is hosted on one or multiple computer platforms. As an example, a computer system may be a computer platform. As another example, a computer system may be a group of computer platforms, such as a set of blade servers installed in a particular rack or a set of blade servers of a particular rack-based server tray. As another example, a computer system may be a host abstraction (e.g., a container, a virtual machine or other host abstraction) on a single computer platform. As another example, a computer system may be a host abstraction across multiple computer platforms (e.g., a single virtual machine hosted across multiple computer platforms, such as a software-defined server).

Regardless of its particular form, the computer system 102 has associated hardware and software, such as the exemplary hardware 104 and software 130 depicted in FIG. 1. The hardware 104 may include a collection of physical processors 106 (a single processor or multiple processors). As used here, a “collection” of items can refer to a single item or multiple items. A processor 106 can include a microprocessor, a core of a multi-core microprocessor, a microcontroller, a programmable integrated circuit, a programmable gate array, or another hardware processing circuit. As more specific examples, the physical processor 106 may be a CPU core, a collection of CPU cores, a CPU semiconductor package (or “socket”), a GPU core, a collection of GPU cores or a GPU semiconductor package.

The hardware 104 may include a physical memory, which can be implemented using a collection of physical memory modules 110. In general, the memory modules 110 that form the physical memory, as well as other memories and storage media that are described herein, are examples of non-transitory machine-readable storage media. In accordance with example implementations, the machine-readable storage media may be used for a variety of storage-related and computing-related functions of the customer computer system 102. As examples, the memory modules 110 as well as other memories of the customer computer system 102 may include memory devices, such as semiconductor storage devices, flash memory devices, memristors, phase change memory devices, magnetic storage devices, a combination of one or more of the foregoing storage technologies, as well as memory devices based on other technologies. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

In accordance with some implementations, the hardware 104 may include a motherboard 120 upon which other components are mounted. The components that are mounted to the motherboard 120 may include, as examples, the memory modules 110, expansion cards 114, components of a voltage regulation subsystem 122, components of a baseboard management controller (BMC) 116, hardware registers 126, a storage controller 118, a complex programmable logic device (CPLD) 124, programmable hardware devices 112, as well as other and/or different hardware components. The voltage regulation subsystem 122 may provide supply voltages to other hardware components of the computer system 102 and may include a CPLD 124, which controls a supply voltage sequencing of the voltage regulation subsystem 122.

As used herein, a “BMC,” or “baseboard management controller,” is a specialized service processor that monitors the physical state of a server or other hardware using sensors and communicates with a management system through a management network. The BMC may also communicate with applications executing at the operating system level through an input/output controller (IOCTL) interface driver, a representational state transfer (REST) API, or some other system software proxy that facilitates communication between the BMC and applications. The BMC may have hardware level access to hardware devices that are located in a server chassis including system memory. The BMC may be able to directly modify the hardware devices. The BMC may operate independently of the operating system of the system in which the BMC is disposed. The BMC may be located on the motherboard or main circuit board of the server or other device to be monitored. The BMC may be mounted to another board that is connected to the motherboard. The fact that a BMC may be mounted on a motherboard of the managed server/hardware or otherwise connected or attached to the managed server/hardware does not prevent the BMC from being considered “separate” from the server/hardware. As used herein, a BMC has management capabilities for sub-systems of a computing device, and is separate from a processing resource that executes an operating system of a computing device. The BMC is separate from a processor, such as a central processing unit, which executes a high-level operating system or hypervisor on a system.

The hardware registers 126 may include a CPU register, a GPU register, a BMC register, a register on the motherboard 120, or in general, any register that stores data for the customer computer system 102. The hardware 104 associated with the customer computer system 102 may include various other hardware components that are not depicted in FIG. 1, such as network interfaces, bus interfaces, I/O bridges, and I/O devices.

As examples, the software 130 associated with the customer computer system 102 may include one or multiple drivers 142, a unified extensible firmware interface (UEFI) 136, a basic input/output operating system (BIOS) 132, one or multiple applications 140, a virtual machine monitor 146, one or multiple libraries 138, and an operating system 134. Examples of OSes include any or some combination of the following: a Linux OS, a Microsoft WINDOWS OS, a Mac OS, a FreeBSD OS, and so forth. Moreover, as depicted in FIG. 1, in accordance with some implementations, the software 130 may include an agent 141 that collects system information for the troubleshooting analysis engine 162.

The customer computer system 102 may store one or multiple logs 148 (e.g., system event logs) and may contain one or multiple software registers 149. Moreover, in accordance with some implementations, the customer computer system 102 may store data representing a manifest 143 (e.g., a cryptographically signed manifest) of the hardware component and software component inventory of the system 102. Data stored in the software registers 149, the hardware registers 146, the logs 148 and data representing the manifest 142 may provide the system information data 156 for the customer computer system 102, in accordance with example implementations. In accordance with further implementations, the data representing the hardware and/or software inventory of the customer computer system 102 may be stored in another computer system, such as, for example, in a management server, and the troubleshooting analysis engine 162 may gather this information from the other computer system.

As used herein, an “engine,” such as the troubleshooting analysis engine 162 and component engines of the engine 162 described herein, can refer to one or multiple circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. Alternatively, an “engine,” such as the troubleshooting analysis engine 162 and component engines of the engine 162, in accordance with some implementations, can refer to a combination of one or more hardware processing circuits and machine-readable instructions (software and/or firmware) executable on the one or more hardware processing circuits.

In accordance with some implementations, the troubleshooting analysis engine 162 and its component engines may be formed from one or multiple processors 164 of the customer service computer platform 160 executing machine-readable instructions 168 (i.e., “software”) that are stored in a memory 166 of the customer service computer platform 160. As examples, a processor 164 may include one or multiple CPU cores, one or multiple GPU cores, or a combination of CPU and GPU cores.

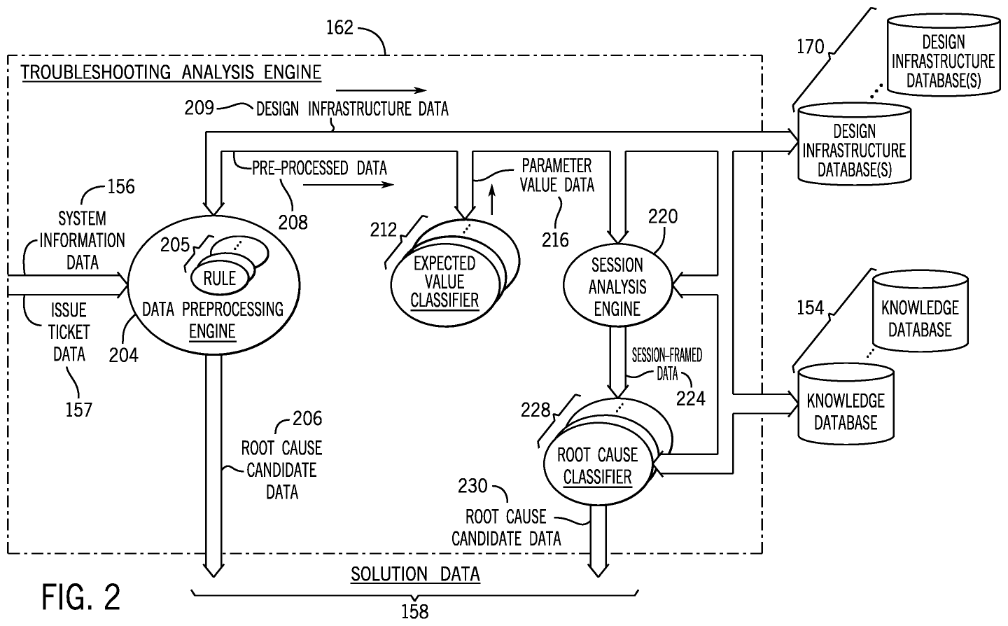

FIG. 2 depicts a block diagram of the troubleshooting analysis engine 162 in accordance with some implementations. Referring to FIG. 2, in accordance with some implementations, the troubleshooting analysis engine 162 includes a data preprocessing engine 204. As depicted in FIG. 2, the data preprocessing engine 204 receives the system information data 156 and the issue ticket data 157. In accordance with some implementations, the data preprocessing engine 204 sorts and organizes the system information data 156 into a predefined format, and applies one or multiple correlation rules 205 to the system information data 156. In this manner, the system information data 156 may, for a given correlation rule 205, provide input that causes the application of the correlation rule 205 to provide an output. The output of the correlation rule 205 may serve one of several different purposes, as further described herein.

The correlation rules 205, in accordance with some implementations, may be used by the data preprocessing engine 104 to identify configuration violations. Here, a “configuration violation” refers to a particular configuration of the customer computer system, which is deemed to be undesirable. As an example, a configuration violation may be due to a hardware component being installed in the customer computer system, which is incompatible with one or multiple other hardware components and/or one or multiple software components of the system. As another example, a configuration violation may be due to a software component being installed in the customer computer system, which is incompatible with one or multiple other software components and/or one or multiple hardware components of the system. As another example, a configuration violation may be due to one or multiple configuration settings of the customer computer system. An another example, a configuration violation may be due to a firmware version or a software version no longer being supported.

The identification of a particular configuration violation may identify the root cause of an issue. Accordingly, for some issues, the application of a correlation rule 205 may readily identify a root cause of the issue. For example, the application of a particular correlation rule 205 may determine that, based on a date code of a voltage regulator integrated circuit (IC) of the computer system and a motherboard serial number of the computer system, that the voltage regulator IC is not compatible with the motherboard, thereby generating a configuration violation. An compatible voltage regulator IC may, for example, be a root cause of CPU performance issues. As another example, the application of a particular correlation rule 205 may determine that a particular option card is not compatible with the computer system, and an incompatible option card may be a root cause of issues affiliated with the option card. In accordance with some implementations, if an identified configuration violation is associated with the issue, then the data preprocessing engine 204 has identified the corresponding root cause and provides rule-based root cause candidate data 206 as the solution data 158.

In accordance with some implementations, the application of a particular correlation rule 205 may indicate that a corresponding configuration rule has not been violated. For example, the application of a particular correlation rule 205 may indicate that a firmware version is valid or a power supply unit is valid.

As further described herein, the candidate root causes for other issues may be relatively more complex and may not readily be directedly identified using the correlation rules 205. For such issues, the data preprocessing engine 204 may use the correlation rules 205 to correlate one or multiple design infrastructures of the customer computer system with the issue. For example, in accordance with some implementations, the data preprocessing engine 204 may provide input to a given correlation rule 205 representing a particular issue identified by a user and certain input items from the system information data. Based on these inputs, the application of the correlation rule 205 may, for example, identify whether a particular design infrastructure of the computer system is to be deemed correlated to the issue.

For example, a particular correlation rule 205 may be associated with a particular voltage regulation circuit (i.e., a design infrastructure) of the computer system and may provide a result (e.g., a Boolean result or a correlation coefficient) representing whether the supply voltage circuit is associated with the issue. As a more specific example, the issue may be that a CPU frequency is low and is locked, and the application of a particular correlation rule 205 associated with a supply voltage circuit of the computer system may reveal, based on the issue and system information, that the issue is correlated with the supply voltage circuit. Other correlation rules 205 may provide indications of whether issues are associated with certain design infrastructures. For example, a particular correlation rule 205 may be associated with an evaluation of whether option cards of the computer system are valid for the particular computer system configuration. Continuing the example, the correlation rule 205 may, for example, reveal that an issue of a low performance networking connection is due to a particular primary riser board of the computer system.

Although correlating a particular design infrastructure of the computer system with a particular issue is specifically described herein, in accordance with further implementations, the data preprocessing engine 204 may use other techniques to identify design infrastructures that are correlated with particular issues. For example, in accordance with some implementations, the data preprocessing engine 204 may access a database that sets forth correlation coefficients that are indexed by issues and identify, based on this information, associated design infrastructure(s) for the issue based on their associated correlation coefficient(s).

As another example, in accordance with some implementations, the data preprocessing engine 204 may set up the design infrastructure correlation as a classification problem. In this manner, the data preprocessing engine 204 may include one or multiple machine learning-based classifiers that classify a particular issue as being correlated to one or possible multiple design infrastructures, which correspond to different classes.

In accordance with example implementations, data preprocessing engine 204 searches one or multiple design infrastructure databases 170 to retrieve design infrastructure data 209, which represents the design infrastructure(s) that were correlated with the issue. As depicted in FIG. 2, in accordance with example implementations, the data preprocessing engine 204 provides preprocessed data 208, which includes the formatted system information data.

As depicted in FIG. 2, in accordance with example implementations, the troubleshooting analysis engine 162 includes one or multiple expected value classifiers 212. The expected value classifier 212 analyzes the system information data for the customer computer system for purposes of identifying any parameter values of the system information data, which are unexpected. In this context, an “unexpected” value refers to a number, logic level or range that is different from the corresponding number, logic level or range, respectively, observed in a computer system that has no issues. As an example, an unexpected value may be a set bit (e.g., a CPU hot bit) that is expected to be cleared bit. As another example, a sensed temperature may be above a maximum temperature threshold. As other examples, expected ranges may correspond to a maximum latency value, a minimum available bandwidth specification, a range for a performance-related parameter, an instructions per second (IPS) minimum threshold, a CPU utilization minimum specification, a minimum response time, as well as other parameters and criteria.

In accordance with some implementations, the expected value classifier 212 may use a supervised machine learning. In this manner, a machine learning model that is used by the expected value classifier 212 may be initially trained based on labeled training data. As an example, the labeled training data may be derived from a knowledge database and/or expert guidance. As a more specific example, the training data may represent a history of observed parameter values from computer systems, labels designating normal ranges and normal values for the parameter values and information regarding the states of the computer systems. In accordance with some implementations, the historical data may include data representing issue tickets, logs, engineering advisories and/or customer advisories. In accordance with some implementations, the machine learning model used by the expected value classifier 212 to identify expected and unexpected parameter values may be updated over time based on labeled data provided by expert guidance. For example, in accordance with some implementations, the solution results provided by the expected value classifier 212 may be regularly audited by experts (e.g., engineers) for purposes of assessing the accuracies of the normal values and normal value ranges determined by the classifier 212 and if appropriate, changing the troubleshooting analysis engine's assessment of unexpected parameter values to provide labeled feedback to the classifier 212. As an example, in accordance with some implementations, historical data gathered from multiple computer systems may be used to provide labeled feedback to the expected value classifier 212.

In accordance with further implementations, the expected value classifier 212 may use unsupervised machine learning. As other examples, in accordance with further implementations, the expected value classifier 212 may use other types of machine learning (other than supervised or unsupervised learning), such as, reinforcement learning or semi-supervised machine learning.

The machine learning model that is used by the expected value classifier 212 may take on any of a number of different forms, depending on the particular implementation. As examples, the model may be an artificial neural network (ANN), a decision tree, a support vector machine (SVM), a regression process, a Bayesian network, a Gaussian process or a genetic algorithm.

In accordance with example implementations, the expected value classifier(s) 212 provide parameter value data 216 to a session analysis engine 220 of the troubleshooting analysis engine 162. The parameter value data 216, in accordance with some implementations, includes one or multiple parameter values that have been identified by the expected value classifier(s) 212 as being unexpected. In accordance with some implementations, the parameter value data 216 may include parameter values that are expected. Moreover, in accordance with some implementations, the parameter value data 216 may be prefiltered (e.g., by the classifier(s) 212 or by the data preprocessing engine 204) to exclude parameter values that are not related to the design infrastructure(s) that have been designated as being correlated with the issue.

The session analysis engine 220 time frames the parameter values (e.g., unexpected value(s) and expected parameter values) into one or multiple data units, which are respectively associated with segments of time, referred to herein as “sessions.” More specifically, in this context, a session refers to a contiguous interval of time, which contains the time or times at which the issue occurred. A data unit that is associated with a particular session may include one or multiple unexpected parameter values and one or multiple expected parameter values that were logged during the session. As an example, in accordance with some implementations, the session analysis engine 220 may set the time boundaries of a session based on a predefined window of time (e.g., a predetermined window of X milliseconds or Y microseconds) that encompasses the time when a particular issue occurred. In accordance with some implementations, the session analysis engine 220 may determine the time boundaries of a session and package parameter values that were logged in that session into a time-framed data unit. The data unit may contain expected parameter values and one or multiple parameter values that were identified as being unexpected. The data unit, in turn, may provide features for a root cause classification problem that is solved by one or multiple root cause classifiers 228 of the troubleshooting analysis engine 162.

In accordance with some implementations, the session analysis engine 220 may use machine learning to time frame parameter values into one or multiple data units that are associated with respective sessions. For example, in accordance with some implementations, the session analysis engine 220 may include one or multiple machine learning-based classifiers, which are constructed to analyze parameters and parameter values for purposes of determining selected parts of the system information data that are relevant to the particular issue. In this manner, in accordance with some implementations, the machine learning classifier(s) identifies subsets of data correlated to the issue.

In accordance with some implementations, the root cause classifier(s) 220 receive session framed data 224 (which represent the time-framed data units) from the session analysis engine 220. The root cause classifier(s) 220 then determines, based on the session framed data 224 and the design infrastructure data 209, one or multiple candidate root causes of the issue. As depicted in FIG. 2, the candidate root cause(s) may be represented by root cause candidate data 230 and be part of the solution data 158 that is provided by the troubleshooting analysis engine 162.

In accordance with some implementations, the root cause classifier 228 may use supervised machine learning, in which a machine learning model that is used by the classifier 228 may be initially trained based on labeled training data. As an example, the labeled training data may be derived from a knowledge database and/or expert guidance. As a more specific example, the training data may represent a history of determined candidate root causes for a given design infrastructure and the features which form the bases for the root cause determinations. In accordance with some implementations, the machine learning model that is used by the root cause classifier 228 may be updated over time based on labeled data provided by expert guidance. For example, in accordance with some implementations, the solution results provided by the root cause classifier 228 may be regularly audited by experts (e.g., engineers) for purposes of assessing the accuracies of the candidate root causes identified by the classifier 228 and if appropriate, changing root cause identifications to provide labeled feedback to the classifier 228. As an example, in accordance with some implementations, feedback from users regarding solutions that cured their issues may be used to provide labeled feedback to the root cause classifier 228.

In accordance with further implementations, the root cause classifier 228 may use unsupervised machine learning. As other examples, the root cause classifier 228 may use other types of machine learning (other than supervised or unsupervised learning), such as, reinforcement learning or semi-supervised machine learning.

A machine learning model used by the root cause classifier 228 may take on any of a number of different forms, depending on the particular implementation. As examples, the model may be an ANN, a decision tree, an SVM, a regression process, a Bayesian network, a Gaussian process or a genetic algorithm.

In accordance with some implementations, the root cause classifier 228 may receive a feature vector, which dimensions correspond to parameter values (both expected and unexpected) that are associated with a particular design infrastructure during a session that includes the time at which the issue occurred. In accordance with some implementations, the feature vector may have dimensions that correspond to features of the design infrastructure. In accordance with some implementations, the root cause classifier 228 may assign individual weights to certain dimensions in a manner that prioritizes the relative priorities of some dimensions over other dimensions.

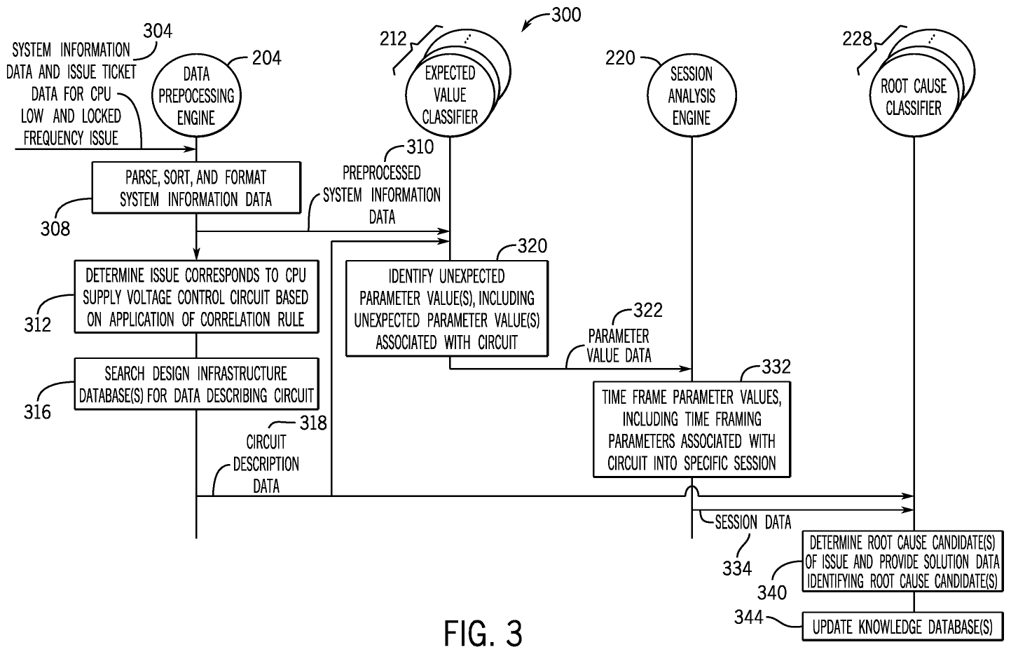

FIG. 3 is an illustration 300 of the troubleshooting analysis engine diagnosing root causes associated with an issue of a CPU of the computer system under evaluation having a low and locked frequency. Referring to FIG. 3, for this example, the data preprocessing engine 204 receives system information 304, and data representing the issue of the CPU being low and having a locked frequency. The data preprocessing engine 204 parses and sorts the system information into a predetermined format, as indicated at 308, and determines at 312 that the issue corresponds to a CPU supply voltage control circuit by applying a correlation rule. As depicted at 316, in accordance with example implementations, the data preprocessing engine 204 searches one or multiple databases for data describing the CPU supply voltage control circuit and provides (as depicted at 318) circuit description data to a root cause classifier 228.

An expected value classifier 212, based on preprocessed system information data 310 provided by the data preprocessing engine 204 to identify 320 an unexpected parameter associated with the CPU supply voltage circuit. For this particular example, the unexpected parameter may be a CPU hot bit, which is a bit of a CPU register indicating that the CPU frequency has been lower due to a supply voltage to the CPU exceeding a predefined threshold. The classifier 212 may then provide unexpected value data to the session analysis engine 220, as depicted at 322.

The session analysis engine 220 may then time frame parameter values into a particular session, as depicted at 332 and provide corresponding session data 334 to a root cause classifier 228. The root cause classifier 228 may then identify (as depicted at 340) one or multiple root cause candidates of the issue and update one or multiple knowledge databases 344 with data representing the issue and the determined candidate root cause(s).

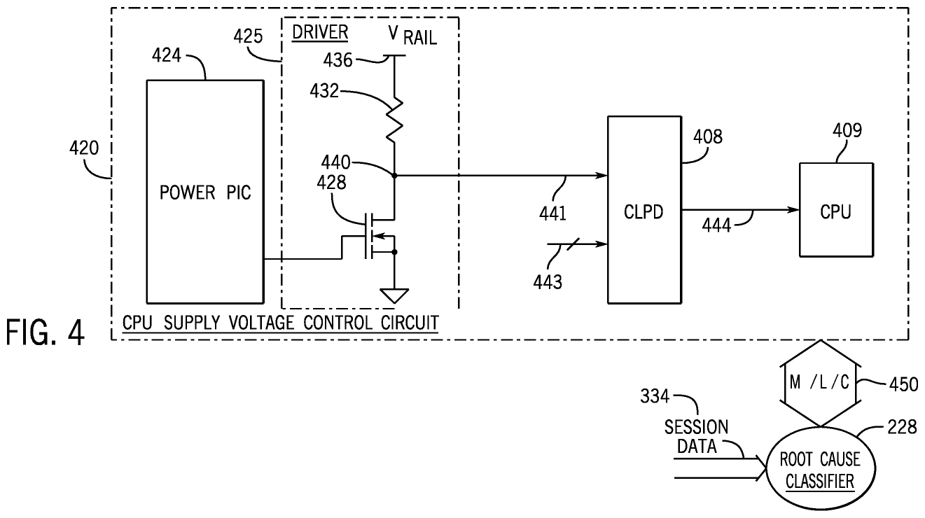

FIG. 4 depicts a CPU supply voltage circuit 420 associated with the above-described CPU low frequency issue for purposes of further illustrating analysis of the issue by the troubleshooting analysis engine. The circuit 420 includes a CPLD 408 that has an output terminal 444 that is coupled to a CPU hot bit input of a CPU 409. the CPLD 408 for this example is constructed to assert the output terminal 444 in response to an input terminal 441 being asserted (e.g., being driven low) by a driver 425. As also depicted in FIG. 4, the CPLD 408 may have multiple additional input terminals 443 that control whether or not the CPLD 408 asserts (e.g., drives high) the output terminal 444.

For the following example, the correlation rule applied by the data preprocessing engine of the troubleshooting analysis engine associates the particular input terminal 441 as being part of the design infrastructure that is associated with the CPU low frequency issue. This design infrastructure includes a programmable interrupt controller 424, a driver 425, the input terminal 441, the CPLD 408 and the input terminal 444.

A driver 425 has a node 440 that is coupled to the input terminal 441, and the driver 424 is constructed to (if operating properly) assert the input terminal 441 in response to the programmable interrupt controller 424 asserting aa particular output terminal (of the programmable interrupt controller 424). More specifically, this output terminal of the programmable interrupt controller 424 is coupled to a gate terminal of an n-channel metal-oxide-semiconductor field-effect-transistor (NMOSFET) 428 of the driver 425. The source of the NMOSFET 428 is coupled to ground, and the drain terminal of the NMOSFET 428 is coupled to the node 440. The driver 425 further includes a resistor 432 that is coupled between the node 440 and a power supply rail 436.

As depicted at 450, a root cause classifier 228 analyzes the CPU supply voltage circuit 420 based on session data 334. For this particular example, the session data 334 reveals that even though the programmable interrupt controller 424 did not assert the gate terminal of the NMOSFET 428, the driver 424 asserted (e.g., drove low) the input terminal 441 to the CPLD 408, which resulted in the assertion of the CPU hot bit. Based on the classification applied by the root cause classifier 228, the classifier 228 identifies a defective resistor 432 as being the likely candidate root cause of the CPU low frequency issue. Accordingly, for this example, the root cause classifier 228 provides solution data identifying the resistor 432 and, in accordance with example implementations, associates a particular confidence level, or likelihood, to the identified root cause candidate.

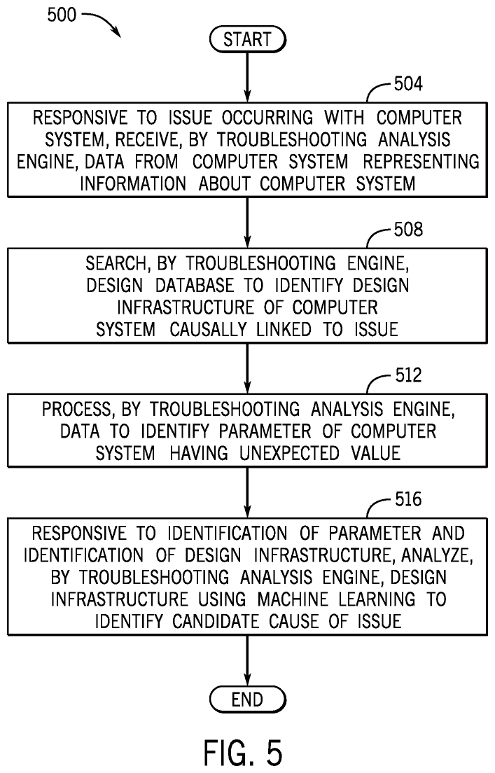

Referring to FIG. 5, in accordance with example implementations, a technique 500 includes, responsive to an issue occurring with a computer system, receiving (block 504), by a troubleshooting analysis engine, data from the computer system representing information about the computer system. The technique 500 includes searching (block 508), by the troubleshooting analysis engine, a design database to identify a design infrastructure of the computer system, which is causally linked to the issue. In accordance with some implementations, the design infrastructure may be identified by applying a correlation rule. In accordance with some implementations, the design infrastructure may be identified using a machine learning classifier. In accordance with some implementations, the machine learning classifier may use supervised machine learning. In accordance with some implementations, the design infrastructure may be a hardware infrastructure, a software infrastructure or a software-based and hardware-based infrastructure.

The technique 500 includes processing (block 512), by the troubleshooting analysis engine, data to identify a parameter of the computer system having an unexpected value. In accordance with some implementations, identifying the parameter having an unexpected value includes identifying an unexpected value based on a normal range or a normal value. In accordance with some implementations, identifying the parameter includes using a machine learning classifier.

The technique 500 includes, responsive to the identification of the parameter and the identification of the design infrastructure, analyzing (block 516), by the troubleshooting analysis engine, the design infrastructure using machine learning to identify a candidate cause of the issue. In accordance with some implementations, using machine learning includes using a machine learning-based classifier. In accordance with some implementations, using the machine learning classifier includes providing time-framed session data to the machine learning classifier. In accordance with some implementations, the design infrastructure may be represented by data that describes a circuit, pseudocode or software routine.

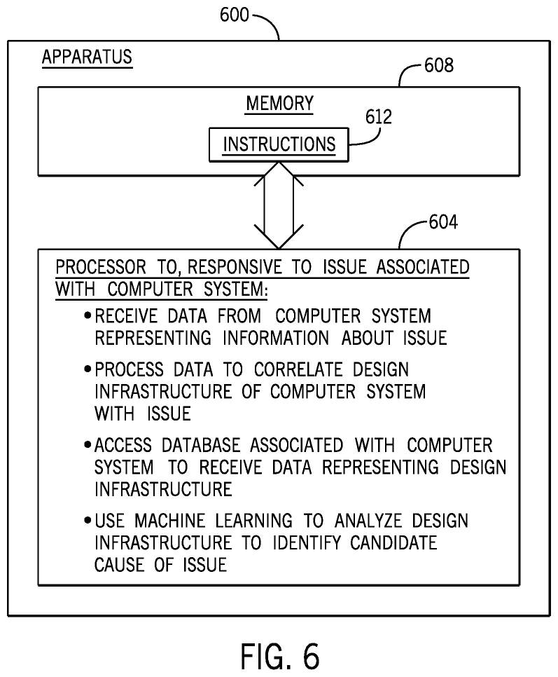

Referring to FIG. 6, in accordance with example implementations, an apparatus 600 includes a processor 604 and a memory 608. The memory 608 stores instructions 612 that, when executed by the processor 604, cause the processor 604 to, responsive to an issue that is associated with a computer system, receive data from the computer system representing information about an issue that is associated with the computer system. In accordance with some implementations, the processor may include one or multiple CPU cores and/or one or multiple GPU cores. In accordance with some implementations, the instructions 612 may cause the processor 604 to receive information about the computer system from sources other than the computer system, such as, for example, a knowledge database. In accordance with some implementations, the computer system may be a single computer platform or may include a collection of computer platforms. In accordance with some implementations, the computer system may be a logical abstraction of hardware.

Responsive to the issue, the instructions 612, when executed by the processor 604, further cause the processor 604 to process the data to correlate a design infrastructure of the computer system with the issue and access the database that is associated with the computer system to receive data representing the design infrastructure. In accordance with some implementations, the processor 604 may correlate the design infrastructure with the issue using one or multiple correlation rules. In accordance with some implementations, the processor 604 may correlate the design infrastructure with the issue using one or multiple machine learning-based classifiers. In accordance with some implementations, the processor 604 may correlate the design infrastructure with the issue using one or multiple table lookups.

Responsive to the issue, the instructions 612, when executed by the processor 604, further cause the processor 604 to use machine learning to analyze the design infrastructure to identify a candidate cause of the issue. In accordance with some implementations, the processor 604 may use one or multiple machine learning classifiers to analyze the design infrastructure to identify the candidate cause. In accordance with some implementations, the processor 604 may identify multiple candidate causes of the issue. In accordance with some implementations, the processor 604 may assign likelihoods to respective identified candidate causes of the issue. In accordance with some implementations, the processor 604 may identify a single candidate cause of the issue.

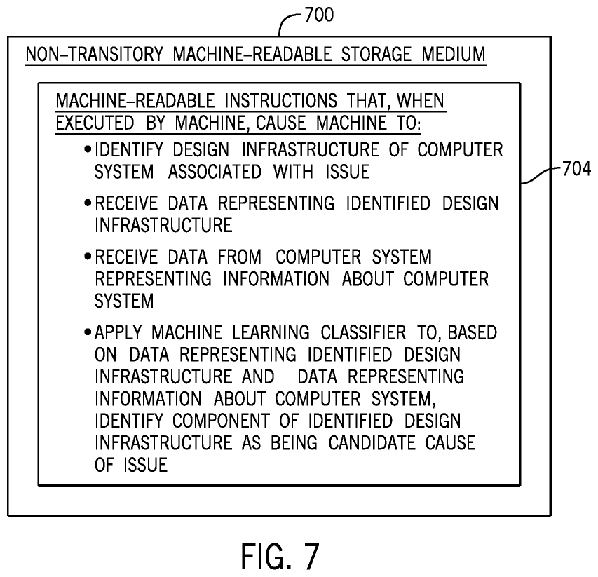

Referring to FIG. 7, in accordance with example implementations, a non-transitory machine-readable storage medium 700 stores machine-readable instructions 704 that, when executed by a machine, cause the machine to identify a design infrastructure of a computer system, which is associated with an issue of the computer system. In accordance with some implementations, the issue may be a configuration issue, a performance issue or a failure of the computer system. In accordance with some implementations, the design infrastructure may be a circuit, a software routine or a combination of a circuit and software of the computer system. In accordance with some implementations, the computer system may be a single computer platform, a collection of multiple computer platforms or a hardware abstraction.

The instructions 704, when executed by the machine, further cause the machine to receive data representing the identified design infrastructure; and receive data from the computer system representing information about the computer system. In accordance with example implementations, the data representing the identified design infrastructure may be data representing a circuit, data representing pseudocode or data representing a routine. The data representing the identified design infrastructure may be derived, in accordance with example implementations, by searching a design infrastructure database.

The instructions 704, when executed by the machine, further cause the machine to apply a machine learning classifier to, based on the data representing the identified design infrastructure and the data representing the information about the computer system, identify a component of the identified design infrastructure as being a candidate cause of the issue. In accordance with some implementations, the machine learning classifier may apply supervised machine learning. In accordance with example implementations, the machine learning classifier may identify multiple candidate causes of the issue, and in accordance with some implementations, the machine learning classifier may assign likelihoods, or probabilities, to the respective identified candidate causes. In accordance with some implementations, the instructions 704, when executed by the machine, may cause the machine to update a knowledge database with results of the issue analysis and identified candidate cause.

In accordance with example implementations, the analysis includes applying a machine learning classifier to, based on input data representing the design infrastructure and the parameter, classify the input data as belonging to a class corresponding to the candidate cause. A particular advantage is that root causes of relatively complex computer issues may be readily identified in a time efficient and resource conserving manner.

In accordance with example implementations, the machine learning classifier may be trained based on historical data that is associated with other computer systems. A particular advantage is that root causes of relatively complex computer issues may be readily identified in a time efficient and resource conserving manner.

In accordance with example implementations, the historical data may include data representing at least one of issue tickets, logs, engineering advisories or customer advisories. A particular advantage is that root causes of relatively complex computer issues may be readily identified in a time efficient and resource conserving manner.

In accordance with example implementations, the analysis may further include providing a confidence that the candidate cause is a root cause of the issue. A particular advantage is that root causes of relatively complex computer issues may be readily identified in a time efficient and resource conserving manner.

In accordance with example implementations, processing the data to identify the parameter includes applying machine learning to determine an expected value or an expected range of values for the parameter. A particular advantage is that root causes of relatively complex computer issues may be readily identified in a time efficient and resource conserving manner.

In accordance with example implementations, processing the data to identify the parameter includes applying machine learning to identify a subset of the data correlated to the issue. A particular advantage is that root causes of relatively complex computer issues may be readily identified in a time efficient and resource conserving manner.

In accordance with example implementations, processing the data includes extracting a subset of data corresponding to a session and processing the subset of data to identify the parameter. A particular advantage is that root causes of relatively complex computer issues may be readily identified in a time efficient and resource conserving manner.

In accordance with example implementations, receiving the data from the computer system includes receiving data representing at least one of an identifier for the computer system, an identifier of a hardware component of the computer system, a version identifier for an operating system of the computer system, or a version identifier for firmware of the computer system. A particular advantage is that root causes of relatively complex computer issues may be readily identified in a time efficient and resource conserving manner.

In accordance with example implementations, receiving the data from the computer system includes receiving data representing contents of hardware registers of the computer system, and a given hardware register of the hardware registers contains the value. A particular advantage is that root causes of relatively complex computer issues may be readily identified in a time efficient and resource conserving manner.

In accordance with example implementations, the given hardware register includes a register of a central processing unit (CPU), a graphics processing unit (GPU), a voltage regulation device, or a complex programmable logic device. A particular advantage is that root causes of relatively complex computer issues may be readily identified in a time efficient and resource conserving manner.

In accordance with example implementations, receiving the data from the computer system includes receiving data representing at least one of a temperature history of the computer system, a workload history of the computer system, or an operation history of the computer system. A particular advantage is that root causes of relatively complex computer issues may be readily identified in a time efficient and resource conserving manner.

While the present disclosure has been described with respect to a limited number of embodiments, those skilled in the art, having the benefit of this disclosure, will appreciate numerous modifications and variations therefrom. It is intended that the appended claims cover all such modifications and variations.

What is claimed is:

1. A method comprising:
responsive to an issue occurring with a computer system, receiving, by a troubleshooting analysis engine, data from the computer system representing information about the computer system;
searching, by the troubleshooting analysis engine, a design database to identify a design infrastructure of the computer system causally linked to the issue;
processing, by the troubleshooting analysis engine, the data to identify a parameter of the computer system having an unexpected value; and
responsive to the identification of the parameter and the identification of the design infrastructure, analyzing, by the troubleshooting analysis engine, the design infrastructure using machine learning to identify a candidate cause of the issue.

2. The method of claim 1, wherein the analyzing comprises applying a machine learning classifier to, based on input data representing the design infrastructure and the parameter, classify the input data as belonging to a class corresponding to the candidate cause.

3. The method of claim 2, further comprising training the machine learning classifier based on historical data associated with other computer systems.

4. The method of claim 3, wherein the historical data comprises data representing at least one of issue tickets, logs, engineering advisories, or customer advisories.

5. The method of claim 1, wherein the analyzing further comprises providing a confidence that the candidate cause is a root cause of the issue.

6. The method of claim 1, wherein processing the data to identify the parameter comprises applying machine learning to determine an expected value or an expected range of values for the parameter.

7. The method of claim 1, wherein processing the data to identify the parameter comprises applying machine learning to identify a subset of the data correlated to the issue.

8. The method of claim 1, wherein processing the data comprises extracting a subset of data corresponding to a session and processing the subset of data to identify the parameter.

9. The method of claim 1, wherein receiving data from the computer system comprises receiving data representing at least one of an identifier for the computer system, an identifier for a hardware component of the computer system, a version identifier for an operating system of the computer system, or a version identifier for firmware of the computer system.

10. The method of claim 1, wherein receiving data from the computer system comprises receiving data representing contents of hardware registers of the computer system, and a given hardware register of the hardware registers contains the value.

11. The method of claim 1, wherein the given hardware register comprises a register of a central processing unit (CPU), a graphics processing unit (GPU), a voltage regulation device, or a complex programmable logic device.

12. The method of claim 1, wherein receiving data from the computer system comprises receiving data representing at least one of a temperature history of the computer system, a workload history of the computer system, or an operation history of the computer system.

13. The method of claim 1, wherein the design infrastructure comprises a hardware infrastructure or a software infrastructure.

14. The method of claim 1, further comprising, providing, by the troubleshooting analysis engine, data representing a resolution for the candidate cause.

15. An apparatus comprising:
a processor; and
a memory to store instructions that, when executed by the processor, cause the processor to:
responsive to an issue associated with a computer system:
receive data from the computer system representing information about an issue associated with the computer system;
process the data to identify a parameter of the computer system associated with the issue;
access a database associated with the computer system to receive data representing a design infrastructure of the computer system associated with the issue; and
use machine learning to analyze the design infrastructure to identify a candidate cause of the issue.

16. The apparatus of claim 15, wherein the instructions, when executed by the processor, further cause the processor to:
determine, based on the information, whether an application of rules identifies a root cause of a set of potential root causes for the issue, wherein each rule of rules is associated with a root cause of the potential root cause and provides an indication of whether the information corresponds to the associated root cause; and
determine to proceed with the processing, searching and analyzing based on the determination that the application of the rules does not identify the root cause.

17. The apparatus of claim 16, wherein a given rule of the rules provides an indication of whether the information violates a configuration rule.

18. A non-transitory machine-readable storage medium to store machine-readable instructions that, when executed by a machine, cause the machine to:
identify a design infrastructure of a computer system associated with an issue of the computer system;
receive data representing the identified design infrastructure;
receive data from the computer system representing information about the computer system; and
apply a machine learning classifier to, based on the data representing the identified design infrastructure and the data representing the information about the computer system, identify a component of the identified design infrastructure as being a candidate cause of the issue.

19. The storage medium of claim 18, wherein the instructions, when executed by the machine, further cause the machine to identify a plurality of candidate causes of the issue.

20. The storage medium of claim 18, wherein the instructions, when executed by the machine, further cause the machine to apply a correlation rule based on the issue and the data from the computer system to identify the design infrastructure.
